(19) United States
(12) Patent Application Publication
(10) Pub. No.: US 2009/0000266 A1
(43) Pub. Date: Jan. 1, 2009

(54) Pneumatic Operating Driving Device

(76) Inventor: Hendrikus Peter van der Waal, Den Haag (NL)

Correspondence Address: LAUBSCHER & LAUBSCHER, P.C., 1160 SPA ROAD, SUITE 2B, ANNAPOLIS, MD, 21403, US

(21) Appl. No.: 12/161,217

(22) PCT Filed: Jan. 23, 2007
(86) PCT No.: PCT/NL2007/000021

§ 371 Date: Jul. 17, 2008

(30) Foreign Application Priority Data
Jan. 25, 2006 (NL) NL 1030998

(51) Int. Cl. F02C 1/02; F02C 5/08

(52) U.S. Cl. 60/39.76; 60/520

(57) ABSTRACT

A pneumatic operating driving device, comprising at least one rotor (1) being connected to a rotatable supported shaft (3) and being brought into rotation by means of air. Near the circumference of said rotor (1), at least one cylinder (5, 15) is positioned, comprising at least one combustion chamber (8) and in which a piston (9, 20) is freely movable, which from a position near said combustion chamber (8) is moved to the other end of said cylinder by means of burning fuel in said combustion chamber, for blowing air out of a nozzle (12) towards said rotor (1). Means, such as a spring (10), are provided to bring said piston (9) back to its original position either said cylinder (15) is executed for double working. A number of cylinders (5, 15) is present divided over the circumference of the rotor (1), in which the point of time of the ignition in the combustion chambers (8) of the cylinders varies.

The invention relates to a pneumatic operating driving device, comprising at least one rotor being connected to a rotatable supported shaft and which is brought into rotation by means of air.

In case of the known devices of this kind compressed air is produced in a separate device, said air being supplied to the pneumatic operating device.

Now the object of the invention is to combine these separate devices to one single device. By this less space is needed and less guiding tubes are necessary.

According to the invention this is obtained by the fact that at least one cylinder is fixedly positioned near the circumference of said rotor, said cylinder comprising a combustion chamber near at least one end of it, a piston being freely movable mounted in said cylinder, which piston can be moved from a position near said combustion chamber to the other end of said cylinder by means of burning fuel in said combustion chamber, by said piston air is blown towards said rotor out of a nozzle present near the other end of said cylinder, means being provided to bring said piston back from its last mentioned position to its first mentioned position.

So the air compressed by the movement of said piston in said cylinder is directly used for bringing said rotor into rotation. Generally speaking said rotor will be positioned on a shaft being connected to a device which has to be driven.

Said means for bringing said piston back towards the end of the cylinder provided with the combustion chamber, might be in the shape of a spring, acting directly or indirectly upon said piston.

Moving back said piston towards its original position might also be obtained by the fact that said cylinder and piston are executed for double acting, for which near each end of said cylinder a nozzle and a combustion chamber are present, a valve being provided at each end of said cylinder, said valve being pressed against a seat when said piston is positioned near the related end of said cylinder, said piston then being moved towards the other end of said cylinder by means of the burning of fuel in the combustion chamber, said valve being drawn again towards said piston by the action of a spring.

In case of such an embodiment air will be blown in opposite directions out of the nozzles present near the ends of the cylinder. Now it might be possible to guide the air coming out of one of said nozzles in the same direction as the air coming out of the other nozzle by means of a bent piece. This, however, will cause loss of energy.

In connection with this it can be provided that use is made of two rotors, rotating in opposite directions in which the one is fixedly connected to the shaft to be driven and the other is rotatable positioned on said shaft, said last rotor being provided with an inner toothing co-operating with at least one gear wheel which as such co-operates with a gear wheel fixed on said shaft.

Generally speaking a number of cylinders will be present divided over the circumference of the rotor, in which the point of time of the ignition in the combustion chambers of the cylinders can be varied.

By this it is obtained, that on said rotor either rotors a more equally divided force is executed.

The invention is further elucidated by means of embodiments, shown in the drawing, in which:

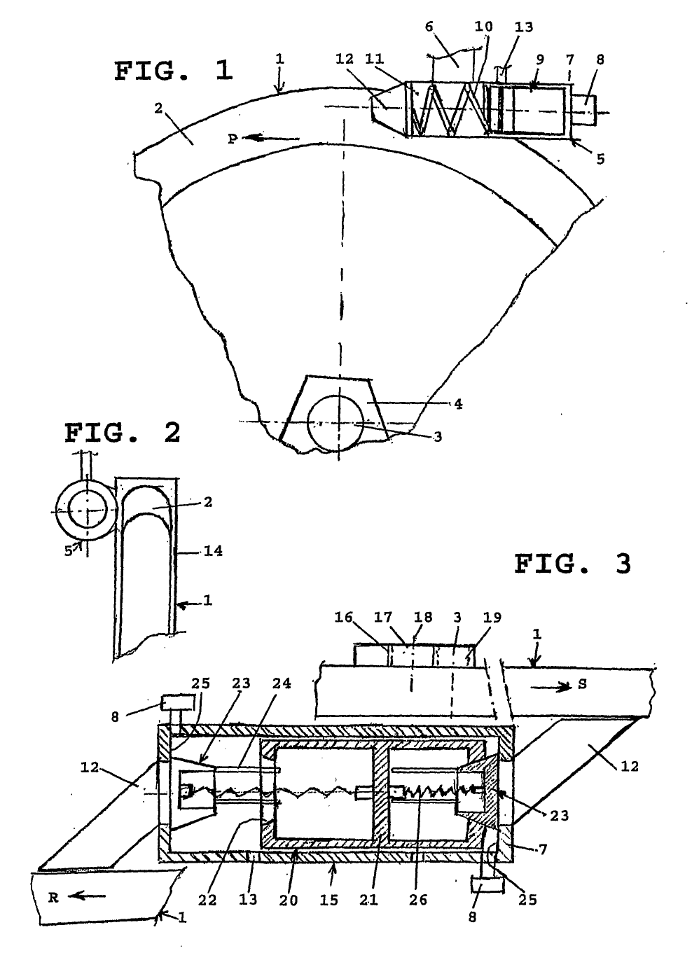

FIG. 1 schematically shows a view of a part of a device according to a first embodiment of the invention, seen in the direction of the rotation axis of the rotor;

FIG. 2 schematically shows a view of a part of the device of FIG. 1 in a direction at right angles to the view of FIG. 1 and from the right side of this; and

FIG. 3 schematically shows a view of a part of a second embodiment of a device according to the invention.

The device according to FIGS. 1 and 2 comprises the rotor 1, being provided with vanes 2 and being connected to the shaft 31 which is rotatable supported by the framework 4.

A cylinder 5 is connected to the framework 4 by means of a support 6 in a not further indicated way. One end 7 of said cylinder 5 is provided with a combustion chamber 8. Said combustion chamber is provided with valves and with an ignition device, not further indicated.

A freely movable piston 9 is positioned in said cylinder 5 and engages the wall of said cylinder but is drawn at some distance from it for clearness' sake.

The piston 5 is influenced by the spring 10, pressing said piston to the end 7 of said cylinder. When a fuel mixture is ignitioned in said combustion chamber 8 said piston 5 is pressed towards the other end 11 of said cylinder 5 and the air, present in said cylinder will be pressed outwardly via the nozzle 12.

The air leaving said nozzle 12 will land against the vanes 2 of said rotor 1, such that this will be rotated and is taken the shaft 3 with it. The direction of rotation of the rotor 1 is indicated by means of the arrow P.

The axis of said nozzle 12 will make a given angle with the axis of said cylinder 5 to direct the flow of air in the right direction onto the vanes 2 of said rotor 1. It is also possible that the axis of said cylinder 5 extends in a given direction such that the end 7 of said cylinder is positioned at a greater distance from the plane of said rotor than the end 11 of said cylinder 5. By this the flow of air towards said rotor can be made as favourable as possible.

Obviously the cross-section of the nozzle 12 might change towards said rotor 1, such as from circular to rectangular. By this a better flow of the air towards said vanes can be obtained.

Further said cylinder 5 is provided with an outlet 13, which is opened when said piston 9 has reached the end of its stroke. Said outlet can be connected to a central tube, such that said flue gasses possibly might be used. Said outlet 13 might be provided with a controlled valve, such that the position of the outlet is less critical. Then also the opening and closing of said valve can be controlled. Controlling can be done synchroniously with the controlling of the valve either valves and e.g. of the ignition device of the combustion chamber 8.

Said rotor 1 with the vanes 2 is enclosed by a housing 14, being locally provided with a connecting piece, passing into said nozzle 12.

In case of the embodiment according to FIG. 3 corresponding parts are indicated by the same reference numbers as used for the embodiment according to the FIGS. 1 and 2.

In case of this embodiment said cylinder 15 is provided with a nozzle 12 at both of its ends, each of these being directed to a rotor 1. As in case of the first embodiment one of said rotors is directly connected to the shaft 3. The other rotor is freely rotatable on the shaft 3 and is provided with an inwardly directed toothing 16 co-operating with at least one toothed wheel 17, being rotatable on a shaft 18 which is connected to the framework 4. The toothed wheel 17 engages a toothed wheel 19, being fixedly connected to the shaft 3. When the rotor is rotated in a given direction the shaft 3 will rotate in opposite direction, to with in the same direction as it is driven by said other rotor. The rotational direction of said rotors is indicated by the arrows R and S.

A hollow piston 20 is present in said cylinder 15 with in the middle of it a partition 21. Said piston 20 is provided with a seat 22 at its both ends 7, in which a valve 23 can be engaged, being guided by some legs 24. At the other side said valve 23 can tightenly engage a seat 25 of said cylinder 15. Said valve 23 is drawn towards the partition 21 of said piston 20 by means of a draw spring 26.

Said cylinder 15 is provided with a combustion chamber 8 at both of its ends 7, such as this is described by means of the FIGS. 1 and 2 and which in the indicated way can be provided with valves, an ignition device etc.

When the parts are in the position indicated in FIG. 3 the piston 20 is just arrived in its most right position and has passed the left outlet 13 and the left valve 23 will be drawn towards the piston 20 by the spring 26. Near the most right side of the cylinder 15 now the combustion chamber 8 is activated by which the right valve 23 is pressed against the seat and the piston 20 is moved towards the left. The left end of said piston, being closed by the related valve 23, will now press air out of the nozzle 12 till the position is reached as shown in the right part of the figure. Then the left combustion chamber 8 is activated and again the position of the parts is obtained as indicated in FIG. 3.

As already described with the help of the FIGS. 1 and 2 the outlets 13 can be connected to each other and various valves and control devices can be applied.

It is remarked that the vanes 2 of the rotor 1 might have the shape of a wing-profile. To form the flow of air towards the vanes as favourable as possible, each vane can be fixed on a radially extending shaft, which is rotatable supported by said rotor. Each shaft can be provided with an arm and said arms can be coupled with one another. At least one arm can be provided with a slotted hole in which a pin is inserted connected to a control disc. Said control disc is non-rotatable but only shiftable mounted on said shaft 3 and can be shifted along said shaft by a control element to rotate the vanes to the desired position. Possibly use can be made of gear wheels or such like.

It will be obvious that only two possible embodiments of a device according to the invention are shown in the drawing and are described above and that many modifications can be made without leaving the scope of the invention as this in indicated in the claims.

So it might be concluded that the basic idea can be found in it that the above description concerns a shaft-to-shaft construction without which said indicated means cannot be applied when those are not assembled with the shaft, so that the shaft-to-shaft construction is forming one whole by which the crank shaft principle is made superfluous.

1. A pneumatic operating driving device, comprising at least one rotor (1) being connected to a rotatable supported shaft (3) and being brought into rotation by means of air, characterized in that at least one cylinder (5,15) is fixedly positioned near the circumference of said rotor (1), said cylinder comprising a combustion chamber (8) near at least one end of it, a piston (9,20) being freely movable mounted in said cylinder, which piston can be moved from a position near said combustion chamber to the other end of said cylinder by means of burning fuel in said combustion chamber, by which piston air is blown out of a nozzle (12), present near the other end of said cylinder, towards said rotor, means being provided to bring said piston (9,20) back from its last mentioned position to its first mentioned position.

2. A device according to claim 1, characterized in that said means for bringing said piston (9) back towards the end of the cylinder (5) provided with the combustion chamber, is in the shape of a spring (10), acting directly or indirectly upon said piston (9).

3. A device according to claim 1, characterized in that said cylinder (15) and piston (20) are executed such that near each end (7) of said cylinder a nozzle (12) and a combustion chamber (8) are present, a valve (23) being provided at each end of said cylinder (15), said valve being pressed against a seat (25) when said piston is positioned near the related end of said cylinder, said piston then being moved towards the other end of said cylinder by means of the burning of fuel in the combustion chamber (8), said valve (23) being drawn again towards said piston by the action of a spring (26).

4. A device according to claim 3, characterized in that two rotors (1) are mounted, rotating in opposite directions, in which the one is fixedly connected to the shaft (3) to be driven and the other is rotatable positioned on said shaft, said last rotor being provided with an inner toothing (16) co-operating with at least one toothed wheel (17). which as such co-operates with a toothed wheel (19) fixed on said shaft.

5. A device according to claim 1, characterized in that a number of cylinders (5,15) is present divided over the circumference of the rotor (1), in which the point of time of the ignition in the combustion chambers (8) of the cylinders can be varied.
